(19) United States
(12) Patent Application Publication
(10) Pub. No.: US 2013/0340741 A1
(43) Pub. Date: Dec. 26, 2013

(54) ACCESSORY MOUNTING SYSTEM FOR APPLIANCE

(71) Applicant: W.C. BRADLEY CO., (US)

(72) Inventors: ANDREW WOLF KAHLER, Fortson, GA (US); WILLIAM LADON HOPKINS, Columbus, GA (US); WILLIAM CLARK TURNER, Columbus, GA (US)

(73) Assignee: W.C. BRADLEY CO., Columbus, GA (US)

(21) Appl. No.: 13/708,330

(22) Filed: Dec. 7, 2012

Related U.S. Application Data
(60) Provisional application No. 61/567,887, filed on Dec. 7, 2011.

(51) Int. Cl. A47J 37/07

(52) U.S. Cl. CPC A47J 37/0786
USPC 126/25 R

(57) ABSTRACT

An appliance having a vertical surface defined by the appliance, a plurality of spaced apart apertures defined in the vertical surface, and a plurality of attachments, each selectively attachable to the vertical surface by anchoring into the plurality of spaced apart apertures.

### CROSS REFERENCE TO RELATED APPLICATIONS

This application claims the priority of U.S. Provisional Patent Application No. 61/567,887 entitled “ACCESSORY MOUNTING SYSTEM FOR COOKING GRILL,” filed Dec. 7, 2011, the contents of which are hereby incorporated by reference.

### BACKGROUND OF THE INVENTION

Most consumers utilizing outdoor cooking grills and similar appliances rely on a varied assortment of tools and accessories to complete their cooking tasks. For example, tongs may be needed for one task while a fork and skewers may be needed for another. Baskets and towel racks are also convenient depending upon the grilling activity. Others may be more concerned with portability of the grill by having handles attached. However, there is limited space for attaching accessories on most grills and other appliances. What one consumer may find important, another may find superfluous. Up until now, once an appliance is assembled, it has not been easy to adjust, change, or move accessories.

What is needed is a system for addressing the above, and related, issues.

### SUMMARY OF THE INVENTION

The invention of the present disclosure, in one aspect thereof, an appliance comprising having a vertical surface defined by the appliance, a plurality apertures defined in the vertical surface at predetermined spaced apart locations, and a plurality of attachments each having a plurality of spaced apart fasteners corresponding to the spaced apart apertures of the vertical surface, and being selectively attachable to the vertical surface by anchoring into the plurality of spaced apart apertures with the fasteners.

The plurality of spaced apart apertures may comprise a plurality of substantially horizontal and equidistantly spaced circular apertures. The vertical surface may define the plurality of spaced apart apertures as a plurality of horizontally oriented funnel shaped openings through the vertical surface. Each of the funnel shaped openings may provide a large opening and a small opening and be oriented with the large opening facing a perimeter of the vertical surface.

In various embodiments, at least one of the plurality of attachments anchors into the plurality of apertures with a threaded post secured with a fastener. At least one of the plurality of attachments may anchor into the plurality of apertures with an angled wire. At least one of the plurality of attachments may anchor into the plurality of apertures with a snap fitting.

The plurality of attachments may comprise at least a wire basket and a utensil holder. Some embodiments further comprise a horizontal surface defining a shelf top, wherein the vertical surface attaches to an edge of the horizontal surface.

The invention of the present disclosure, in another aspect thereof comprises an appliance having a cabinet, at least one shelf affixed to the cabinet and defining a horizontal top surface and a plurality of attached vertical surfaces at a perimeter of the top surface, and a plurality of equidistantly spaced apart apertures at predetermined locations defined in at least one of the vertical surface for selectively anchoring a plurality of attachments having a plurality of fasteners that correspond to the plurality of apertures.

The plurality of spaced apart apertures may comprise a plurality of substantially horizontal and equidistantly spaced circular apertures. In other embodiments, the vertical surface defines the plurality of spaced apart apertures as a plurality of horizontally oriented funnel shaped openings through the vertical surface. Each of the funnel shaped openings may provide a large opening and a small opening and is oriented with the large opening facing a perimeter of the vertical surface.

The invention of the present embodiment, in another aspect thereof, comprises an appliance with a wheeled cabinet, first and second shelves attached to the cabinet on first and second sides of the cabinet, respectively, each of the shelves having an upper horizontal platform and at least one attached vertical surface on a perimeter of the shelves. The appliance includes a plurality of equidistantly spaced apart apertures defined in both of the vertical surfaces, and a plurality of interchangeable attachments that selectively anchor to the vertical surfaces via the apertures.

The apertures may comprise circular openings. In another embodiment, the apertures comprise a plurality of horizontally oriented funnel shaped openings. Each of the funnel shaped openings may provide a large opening and a small opening and be oriented with the large opening facing a perimeter of the vertical surface. In some cases the plurality of attachments comprise a handle, a basket, and utensil rack.

### BRIEF DESCRIPTION OF THE DRAWINGS

FIG. 1 is a perspective view of an appliance according to aspects of the present disclosure.

FIG. 2 is a perspective rear view of an appliance according to aspects of the present disclosure.

FIG. 3 is a perspective view of a portion of an appliance with an attached wire basket accessory.

FIG. 4 is another perspective view of a portion of an appliance with an attached handle accessory.

FIG. 5 is a perspective view of a portion of an appliance with an attached tool holder accessory.

FIG. 6 is a plan view of a portion of an appliance showing potential size and locations of accessory mounting apertures for the end of the appliance.

FIG. 7 is a plan view of a portion of an appliance according to aspects of the present disclosure showing potential size and locations of accessory mounting apertures for the back side of the appliance.

FIGS. 8A-C illustrate one possible configuration of a mounting aperture according to the present disclosure.

FIG. 9 is an interior perspective view of an appliance shelf.

### DETAILED DESCRIPTION OF THE PREFERRED EMBODIMENTS

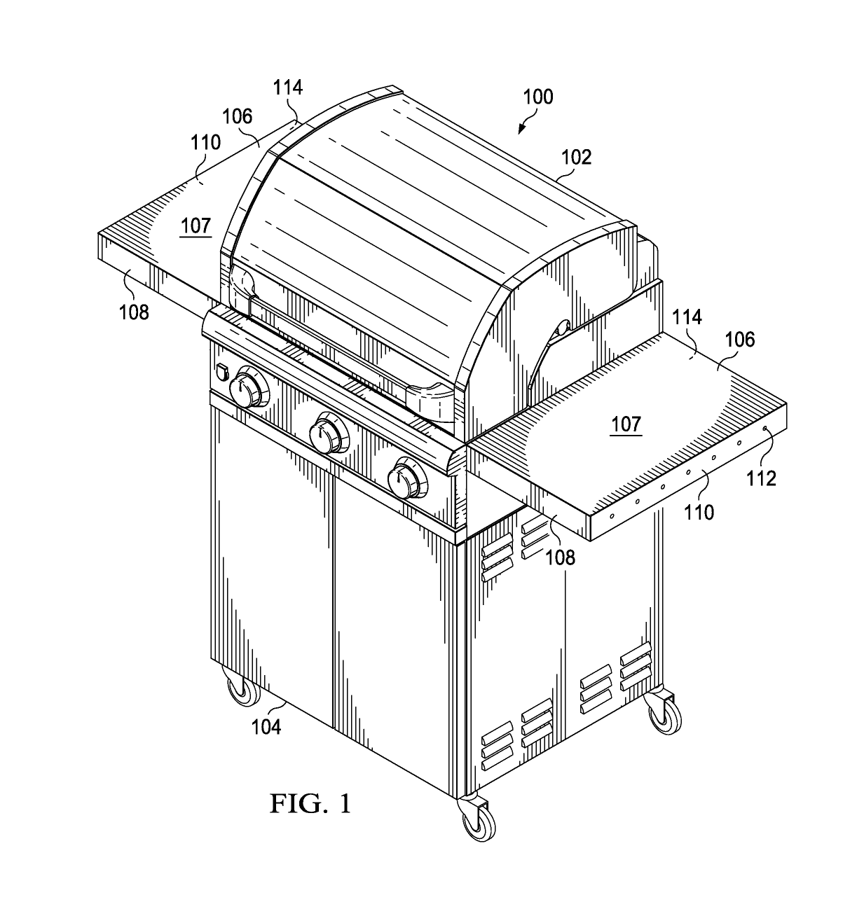

Referring now to FIG. 1, a perspective view of an appliance is shown. The appliance 100 is illustrated here as a grill cart. However, it will be appreciated that the system and methods of the present disclosure are not limited to use with grill carts. For example, the appliance 100 may be, without limitation, a cooler, fryer, smoker, gas grill, charcoal grill, electric grill, infrared grill, traditional stove, or another appliance. In the present embodiment, the appliance 100 is a grill cart that comprises a firebox 102 and cabinet 104. The firebox 102 may be equipped to utilize charcoal, gas, or another heat source. The cabinet 104 generally supports the firebox 102 in a position convenient for a user. The cabinet 104 may provide additional storage space and may be mounted on wheels for ease of movement.

In the present embodiment the appliance 100 has a pair of shelves 106 attached to either side of the firebox 102. In the present embodiment the shelves 106 have a top horizontal surface 107 that may be utilized for storage. They also provide a plurality of attached vertical surfaces, shown here as a front edge 108 and a side edge 110. In the present embodiment the side edge 110 is opposite on the shelf 106 from where the shelf 106 attaches to the firebox 102 and/or cabinet 104. The vertical surfaces 108, 110 may be provided on the perimeter or periphery of the horizontal surface 107 of the shelf 106 to aid in manufacturing. However, the vertical surfaces 108, 110 may be placed anywhere on the appliance 100 in accordance with the present disclosure.

For purposes of the present disclosure, the term “vertical surface” describes a surface that is substantially vertical. In other words, it need not be perfectly vertical for the term to apply. In one aspect, the systems and methods of the present disclosure provide a way for a user to attach and exchange tools or implements that enhance the functionality or utility of the appliance 100. Such tools and enhancements may be most useful when attached to surfaces of the appliance 100 that would otherwise go unutilized or underutilized. Such surfaces are generally not horizontal surfaces (e.g., surface 107) and are therefore denoted as vertical in this disclosure even though they may have some degree of angle from the vertical.

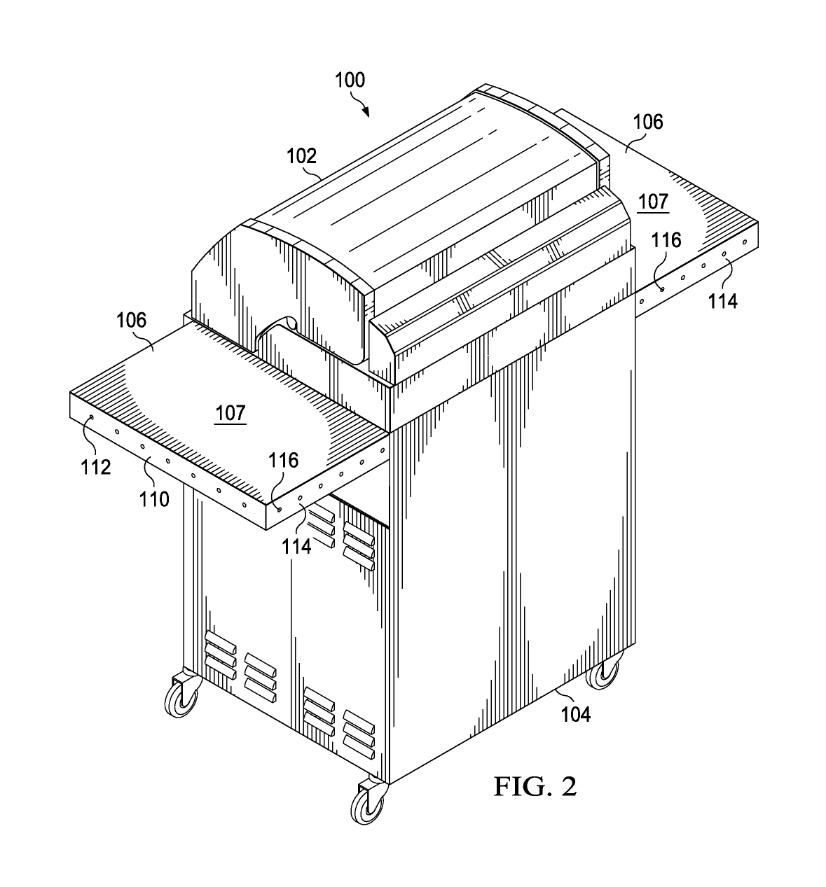

A plurality of accessory mounting apertures 112 may be provided on one or more of the vertical surfaces 110 of the shelves 106. As will be described in greater detail below, the accessory mounting apertures define openings into which accessories may be mounted to increase the utility and/or usability of the appliance 100. The shelves 106 also provide a back vertical surface 114 that can be more easily seen with reference to FIG. 2. In the present embodiment, the back surface 114 of the shelves 106 defines a second plurality of apertures 116. These also may be utilized for mounting of accessory devices as will be described in greater detail below. It is also understood that apertures (not shown) may be provided on the surface 108 instead of, or in addition to, those illustrated on surfaces 110, 114.

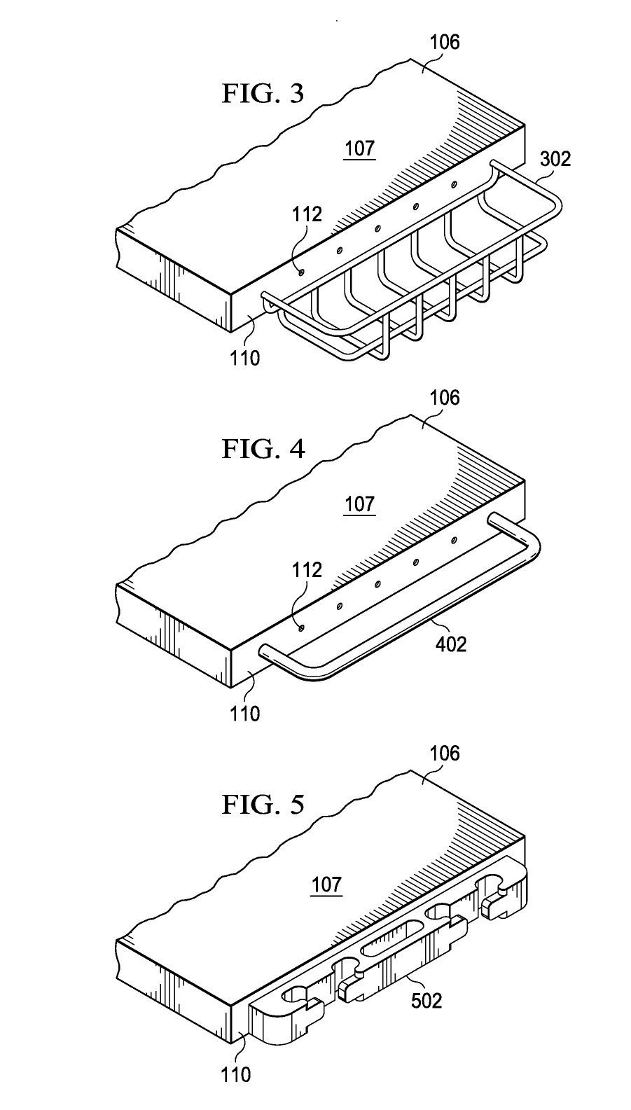

Referring now to FIG. 3, a perspective view of a portion of the appliance 100 is shown. Here a wire basket 302 is shown attached to the end 110 of the shelf 106 via the plurality of apertures 112. It will be appreciated that the basket 302 may be designed with an appropriate shape, and have a corresponding protuberances to mate with the apertures 112. It will also be appreciated that, due to the number and spacing of the apertures 112, an accessory such as the basket 302 need not necessarily interact with each and every one of the plurality of apertures 112.

Referring now to FIG. 4, the appliance 100 is shown with an attached handle 402. The handle 402 is attached to the shelf 106 using one or more of the plurality of apertures 112. In some embodiments, various accessories such as the handle 402 may be secured to the shelf 106 with screws or nuts on the back side of the apertures 112. A relatively secure fastener (e.g., screws or nuts) may be used where the accessory, such as the handle 402, may be subject to lifting or pulling forces.

Referring now to FIG. 5, a portion of the appliance 100 is shown with an attached tool holder 502. In the present embodiment it can be seen that the tool holder 502 defines a plurality of recesses and guide members for retaining a plurality of tools such as forks, skewers, or tongs. The tool holder 502 may be provided with a fastener such as snap fit, or an interference fitting, that cooperates with the apertures 112 (which are covered by the tool holder 502 in the present view).

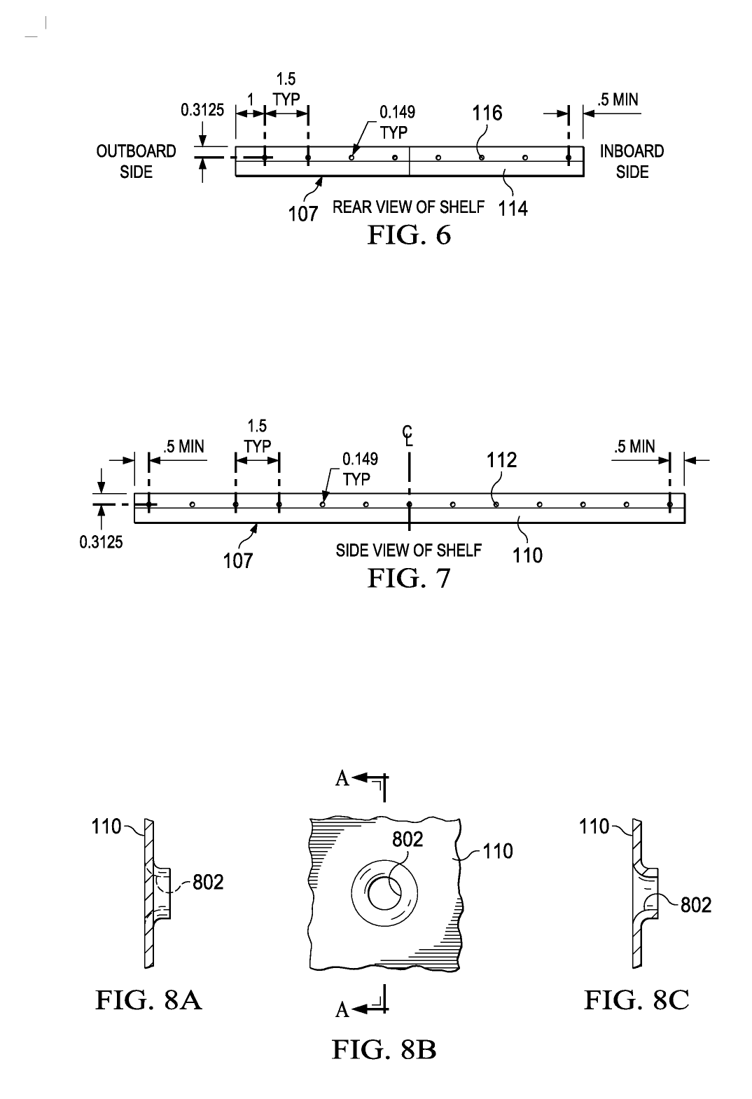

Referring now to FIG. 6, a plan view of one potential configuration for the plurality of apertures 112 on the end 110 of shelf 106 is shown. In the present embodiment an aperture is provided every 1.5″ along the end surface 110 of the shelves 106. It will be appreciated that other spacing may be utilized, and furthermore, that the spacing of the apertures 112 need not be the same across the entire length of the end 110. In the present embodiment, there are no apertures within ½″ of the edge of the end 110. The limit for location of apertures relative to the end of the shelves may vary depending upon the materials used. For instance, a metallic shelf may be able to provide apertures 112 closer to the corner than a shelf built from a polymer. It is also understood that the apertures are shown as round in the present embodiment, but in other embodiments the apertures could define other shapes such as ovals, squares, rectangles, triangles, etc. In addition to simple geometric shapes, the holes could also feature complex shapes such that a tool could only be inserted in one direction and may have to be rotated into place to complete the connection.

Referring now also to FIG. 7, a plan view of one possible configuration of the apertures 116 on the back 114 of the shelf 106 is shown. The apertures 116 may also be varied in size, shape, and location in a manner similar to the apertures 112 previously described. For example, in the present embodiment the apertures are spaced 1.5″ apart, are 0.149″ in diameter, and placed 0.3125″ from the top surface 107 of the shelf 106. However, this may be varied depending upon the needs of the user.

It will be appreciated that the fasteners of the attachable tools or accessories are spaced according to the apertures such that a secure fit may be achieved by the fitting of multiple fasteners into multiple apertures for each attachable tool. The various tools and accessories that may be mounted to the appliance 100 may be selectively attachable and detachable by a user. In other words, a user may select from a plurality of tools or accessories to be attached, and in some cases may change this selection later when needs change. It will also be appreciated that the number of tools or accessories that may be mounted on the shelves 106 via apertures 112 and 116 could vary. It will also be appreciated that the accessories are not meant to be limited to those described herein, which are meant to be exemplary.

Referring now to FIG. 8A, a side view of a mounting aperture 802 is shown. The aperture 802 may be utilized instead of, or in addition to, the circular apertures 112, 116 previously described. In this configuration the aperture 112 is extruded through the end 110 of the shelf 106. This may be done mechanically, with a punch, for example. FIG. 8B shows a frontal view, while FIG. 8C shows a cutaway taken along line AA. In other embodiments the aperture may be formed by punching, cutting, drilling, molding, or some other method and may or may not have an extruded profile as shown in FIGS. 8A-8C.

The extruded profile aperture 802 may be said to have a funnel shaped profile. In one embodiment, the larger funnel opening will face to the outside of the appliance 100 with the smaller opening facing inward. This may aid in the insertion and/or retention of fasteners such as wires or snap fittings.

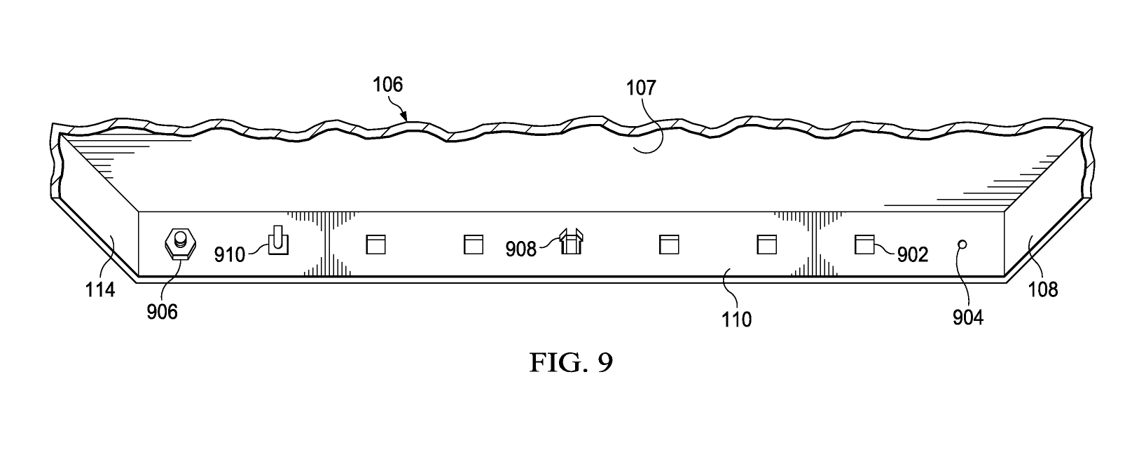

Referring now to FIG. 9, an interior perspective view of an appliance shelf is shown. Here, the shelf 106 is shown from an interior viewpoint facing away from the appliance 100 to reveal the back side of the horizontal surface 110. Additional aperture configurations are shown here by square apertures 902. In some embodiments, more than one aperture type may be used on the same surface. Round apertures 904 are provided here for illustration of this concept.

Also shown in FIG. 9 are a plurality of fastening means to anchor various tools that may be attached to the vertical surfaces of the present disclosure. A bolt (threaded post) is shown secured by a nut 906. This type of fastener may be useful to accessories that may experience a heavy load under use (e.g., handles for lifting). A wire segment or hook 910 is shown attached through one of the square apertures 902. This may be useful for an attachment that experiences loading primarily in a downward direction (e.g., hooks or baskets). Finally a snap fitting 908 is shown in another of the square apertures 902. This type of fastener may be removable, or at least semi-permanent, and may provide for a more finished appearance (e.g., tool holder 502).

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. An appliance comprising:
a vertical surface defined by the appliance;
a plurality apertures defined in the vertical surface at predetermined spaced apart locations; and
a plurality of attachments each having a plurality of spaced apart fasteners corresponding to the spaced apart apertures of the vertical surface, and being selectively attachable to the vertical surface by anchoring into the plurality of spaced apart apertures with the fasteners.

2. The appliance of claim 1, wherein the plurality of spaced apart apertures comprise a plurality of substantially horizontal and equidistantly spaced circular apertures.

3. The appliance of claim 1, wherein the vertical surface defines the plurality of spaced apart apertures as a plurality of horizontally oriented funnel shaped openings through the vertical surface.

4. The appliance of claim 3, wherein each of the funnel shaped openings provides a large opening and a small opening and is oriented with the large opening facing a perimeter of the vertical surface.

5. The appliance of claim 1, wherein at least one of the plurality of attachments anchors into the plurality of apertures with a threaded post secured with a fastener.

6. The appliance of claim 1, wherein at least one of the plurality of attachments anchors into the plurality of apertures with an angled wire.

7. The appliance of claim 1, wherein at least one of the plurality of attachments anchors into the plurality of apertures with a snap fitting.

8. The appliance of claim 1, further comprising a horizontal surface defining a shelf top, wherein the vertical surface attaches to an edge of the horizontal surface.

9. The appliance of claim 1, wherein the plurality of attachments comprises at least a wire basket and a utensil holder.

10. An appliance comprising:
a cabinet;
at least one shelf affixed to the cabinet and defining a horizontal top surface and a plurality of attached vertical surfaces at a perimeter of the top surface; and
a plurality of equidistantly spaced apart apertures at predetermined locations defined in at least one of the vertical surface for selectively anchoring a plurality of attachments having a plurality of fasteners that correspond to the plurality of apertures.

11. The appliance of claim 10, wherein the plurality of spaced apart apertures comprise a plurality of substantially horizontal and equidistantly spaced circular apertures.

12. The appliance of claim 10, wherein the vertical surface defines the plurality of spaced apart apertures as a plurality of horizontally oriented funnel shaped openings through the vertical surface.

13. The appliance of claim 12, wherein each of the funnel shaped openings provides a large opening and a small opening and is oriented with the large opening facing a perimeter of the vertical surface.

14. An appliance comprising:
a wheeled cabinet;
first and second shelves attached to the cabinet on first and second sides of the cabinet, respectively, each of the shelves having an upper horizontal platform and at least one attached vertical surface on a perimeter of the shelves;
a plurality of equidistantly spaced apart apertures defined in both of the vertical surfaces; and
a plurality of interchangeable attachments that selectively anchor to the vertical surfaces via the apertures.

15. The appliance of claim 14, wherein the apertures comprise circular openings.

16. The appliance of claim 14, wherein the apertures comprise a plurality of horizontally oriented funnel shaped openings.

17. The appliance of claim 16, wherein each of the funnel shaped openings provides a large opening and a small opening and is oriented with the large opening facing a perimeter of the vertical surface.

18. The appliance of claim 14 wherein the plurality of attachments comprise a handle, a basket, and utensil rack.
